(19) United States
(12) Patent Application Publication
(10) Pub. No.: US 2026/0251086 A1
(43) Pub. Date: Aug. 27, 2026

(54) COOLANT MANIFOLD FOR AN ENGINE COOLING SYSTEM

(71) Applicant: CUMMINS INC., Columbus, IN (US)

(72) Inventors: Karan Chitkara, Pune (IN); Chuan Wang, Columbus, IN (US); Mayur Sudhir Pote, Pune (IN); Rahul G. Jajoo, Pune (IN)

(73) Assignee: CUMMINS INC., Columbus, IN (US)

(21) Appl. No.: 19/463,399

(22) Filed: Jan. 29, 2026

(30) Foreign Application Priority Data
Feb. 25, 2025 (IN) 202541016576

(51) Int. Cl. F01P 3/20; B60H 1/04; F01P 11/02

(52) U.S. Cl. CPC F01P 3/20; B60H 1/04; F01P 11/029; F01P 2060/12

(57) ABSTRACT

A coolant manifold for an engine cooling system includes a main body. The main body has an outlet port defining an outlet axis that extends in an outlet direction and plurality of inlet ports in fluid providing communication with the outlet port. The plurality of inlet ports includes a first inlet port and a second inlet port. The first inlet port defines a first inlet axis spaced away from the outlet axis. The first inlet axis extends from the main body in a first inlet direction at a first non-zero angle with respect to the outlet direction. The second inlet port defines a second inlet axis spaced away from the outlet axis. The second inlet axis extends from the main body in a second inlet direction at a second non-zero angle with respect to the outlet direction.

### CROSS-REFERENCE TO RELATED APPLICATIONS

The present application claims priority to Indian Provisional Patent Application No. 202541016576, filed Feb. 25, 2025, the contents of which are incorporated herein by reference.

### FIELD

The present application generally relates to a cooling system for an internal combustion engine.

### BACKGROUND

During operation of an internal combustion engine, a fluid system is configured to route a fluid, such as a coolant, to one or more components of the internal combustion engine. For example, the coolant may be provided to an HVAC system, an exhaust gas recirculation system, and/or other component, system, or sub-system.

### SUMMARY

One embodiment of the invention relates to a coolant manifold for an engine cooling system. The coolant manifold includes a main body having an outlet port defining an outlet axis that extends in an outlet direction and plurality of inlet ports in fluid providing communication with the outlet port. The plurality of inlet ports includes a first inlet port and a second inlet port. The first inlet port defines a first inlet axis spaced away from the outlet axis. The first inlet axis extends from the main body in a first inlet direction at a first non-zero angle with respect to the outlet direction. The second inlet port defines a second inlet axis spaced away from the outlet axis. The second inlet axis extends from the main body in a second inlet direction at a second non-zero angle with respect to the outlet direction.

Another embodiment relates to an engine system comprising an engine, at least one cooling system component, at least one non-cooling system component, a downstream coolant component, and a coolant manifold. The coolant manifold comprises a main body defining a central chamber, an outlet port, and a plurality of inlet ports. The outlet port extends in an outlet direction and is fluidly connected to the central chamber and the downstream coolant component. The outlet port defines an outlet axis. Each of the plurality of inlet ports extends in an inlet direction. Each of the plurality of inlet ports is fluidly connected to the central chamber and (i) one of the at least one cooling system component or (ii) one of the at least one non-cooling system component. Each of the plurality of inlet ports defines an inlet axis spaced away from the outlet axis, each inlet axis extending from the main body in an inlet direction at a non-zero angle with respect to the outlet direction.

### BRIEF DESCRIPTION OF THE DRAWINGS

FIG. 1 is a side view of an engine system, according to an example embodiment.

FIG. 2 is a schematic block diagram of an example engine system in accordance with the arrangement of FIG. 1.

FIG. 3 is a perspective view of a coolant manifold of the engine system of FIG. 1.

FIG. 4 is another perspective view of the coolant manifold of FIG. 3.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

In some embodiments, the engine system 100 is a diesel internal combustion engine system. The diesel internal combustion engine system 100 is configured to combust diesel fuel to generate power.

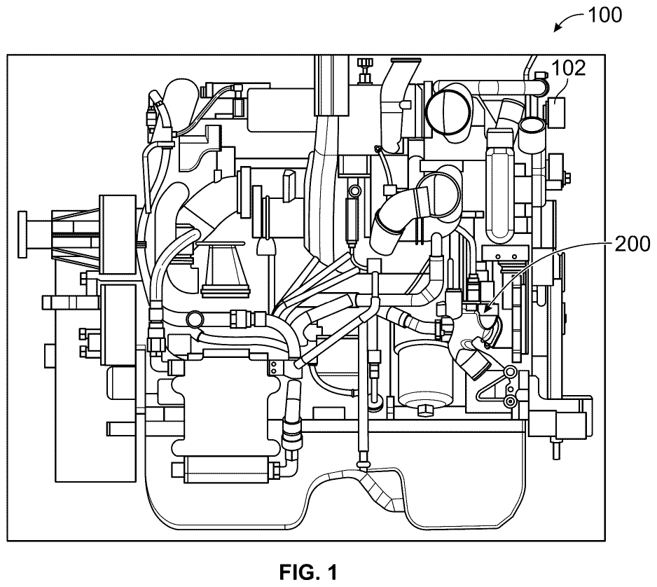

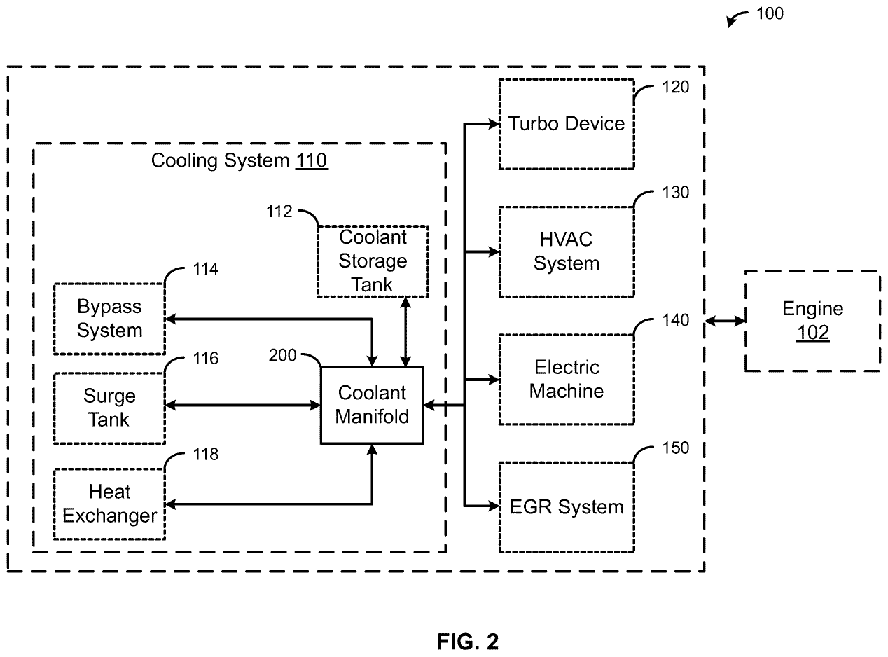

FIG. 2 shows additional components (in dashed lines) which can be included with the engine system 100. For example, the engine system 100 can include a cooling system 110 (e.g., an engine cooling system). In some embodiments, the engine system 100 can include one or more non-cooling system components, including one or more of a turbo device 120, a heating, ventilation, and air condition (HVAC) system 130, an electric machine 140, and/or an exhaust gas recirculation (EGR) system 150. As shown in FIG. 2, the engine 102 is coupled to the cooling system 110, the turbo device 120, the HVAC system 130, the electric machine 140, and the EGR system 150. It should be understood that the engine system 100 can include more or fewer components than as shown in FIGS. 1 and 2.

The cooling system 110 is configured to route a fluid, such as a coolant, to the other components of the engine system 100 (e.g., one or more of the turbo device 120, the HVAC system 130, the electric machine 140, and the EGR system 150). In some embodiments, the coolant is water. In some embodiments, the coolant can be or include another fluid, such as oil, ethylene glycol, propylene glycol, or other suitable type of coolant fluid.

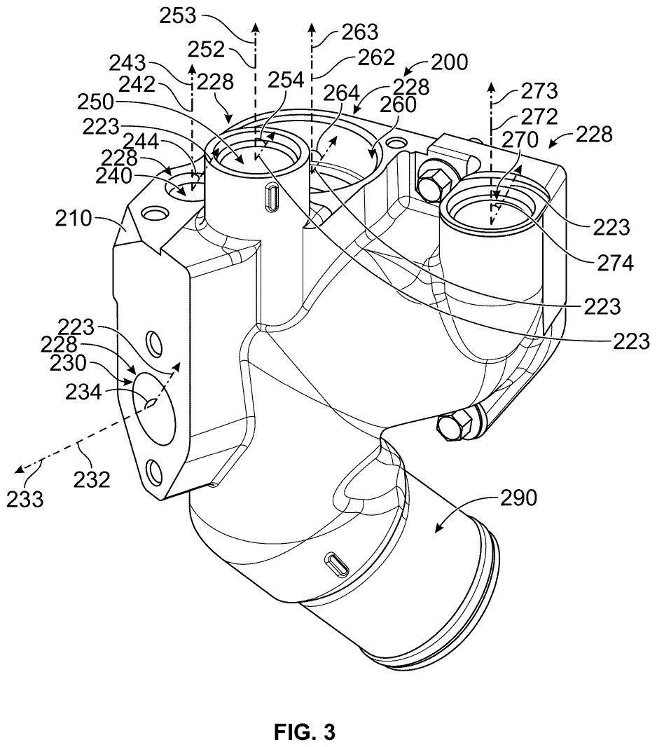

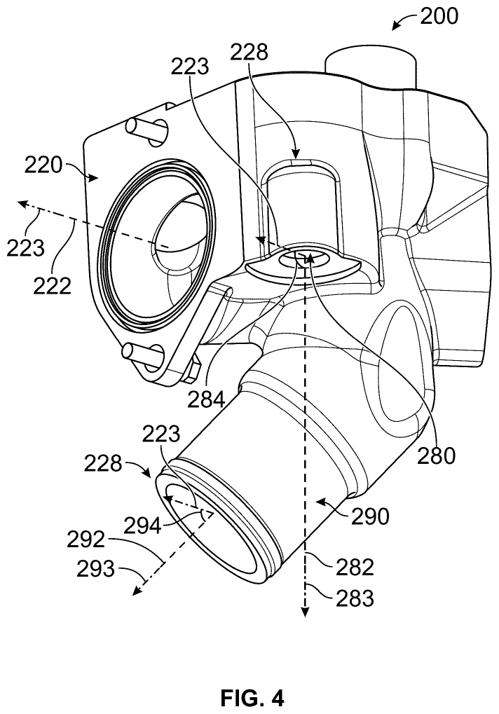

In an example embodiment, the cooling system 110 includes a coolant manifold 200. The coolant manifold 200 is described herein with respect to FIGS. 3 and 4. FIG. 2 shows additional components (in dashed lines) which can be included with the cooling system 110. For example, the cooling system 110 can include a coolant storage tank 112, a bypass system 114, a surge tank 116, and/or a heat exchanger 118. The cooling system 110 can also include one or more conduits, pumps, valves, or other suitable components (not shown) used for routing the fluid between the components of the cooling system 110 (e.g., the coolant storage tank 112, the bypass system 114, the surge tank 116, the heat exchanger 118, and/or a coolant manifold 200) and/or the components of the engine system 100 (e.g., the turbo device 120, the HVAC system 130, the electric machine 140, and/or the EGR system 150).

The coolant storage tank 112 is configured to store the coolant. In some embodiments, the coolant storage tank 112 can include a pump positioned therein or coupled thereto that is configured to route the coolant to the other components of the cooling system 110 (e.g., the bypass system 114, the surge tank 116, the heat exchanger 118, and/or a coolant manifold 200) and/or the components of the engine system 100 (e.g., the turbo device 120, the HVAC system 130, the electric machine 140, and/or the EGR system 150).

The bypass system 114 is configured to route the coolant away from the other components of the cooling system 110 (e.g., the surge tank 116 and/or the heat exchanger 118) and/or the engine system 100 (e.g., the turbo device 120, the HVAC system 130, the electric machine 140, and/or the EGR system 150). For example, the bypass system 114 can include one or more conduits that route the coolant from the coolant storage tank 112 to the coolant manifold 200 such that the coolant “bypasses” one or more other components of the cooling system 110 (e.g., the surge tank 116 and/or the heat exchanger 118) and/or one or more components of the engine system 100 (e.g., the turbo device 120, the HVAC system 130, the electric machine 140, and/or the EGR system 150).

The surge tank 116 is a storage tank with a pressure cap mounted thereto. The tank is mounted at a point higher than the other components of the cooling system 110 (with respect to the direction of gravity). The surge tank 116 provides an air space in the cooling system 110. The air space allows the coolant to expand and contract (e.g., due to thermal expansion/contraction as the temperature of the coolant changes). The surge tank 116 also provides a coolant fill point and an air bleed location. For example, during operation, the coolant heats and expands. The coolant that is displaced by this expansion flows into the surge tank 116. As the coolant circulates, air is allowed to exit via the surge tank 116.

The heat exchanger 118 is configured to facilitate transferring heat from the coolant in the cooling system 110 to another fluid, such as ambient air. For example, the heat exchanger 118 can include a series of finned conduits that the coolant passes through, and the finned conduits facilitate heat transfer from the coolant to the ambient air.

The turbo device 120 (e.g., a turbocharger, a supercharger, a turbine, etc.) is configured to compress air (e.g., ambient air) and provide the compressed air to the engine 102. In some embodiments, the turbo device 120 captures energy from an exhaust gas of the engine 102 to compress the air (e.g., in the case of a turbocharger). In some embodiments, the turbo device 120 receives power from a crankshaft of the engine 102 (e.g., in the case of a supercharger).

The turbo device 120 receives the coolant from the cooling system 110. For example, the turbo device 120 can receive the coolant from the coolant storage tank 112 (e.g., via one or more pumps). The coolant can be used to cool one or more components of the turbo device (e.g., a compressor or a turbine) and/or to cool a fluid flowing therethrough (e.g., the compressed air). The coolant is returned to the cooling system 110 via the coolant manifold 200.

The HVAC system 130 includes one or more components for heating or cooling air provided to a cabin or seating area of a vehicle embodying the engine system 100. For example, the HVAC system 130 can include a compressor, a condenser, a drier, an evaporator, and/or one or more fans or blowers.

The HVAC system 130 receives the coolant from the cooling system 110. For example, the HVAC system 130 can receive the coolant from the coolant storage tank 112 (e.g., via one or more pumps). The coolant can be used to facilitate cooling one or more components of the HVAC system 130 (e.g., the compressor, etc.), and/or a fluid flowing therethrough (e.g., the air that is provided to the cabin/seating area). The coolant is returned to the cooling system 110 via the coolant manifold 200.

The electric machine 140 is or includes at least one of a motor, a generator, a motor-generator, an alternator, or a smart alternator. The electric machine 140 can be configured to receive mechanical power (e.g., from the engine 102 and/or via a regenerative braking operation) and generate electrical power, which can be used to power one or more electrical devices of the engine system 100. The electric machine 140 can be configured to receive electrical power (e.g., from an energy storage system and/or the engine 102 via an alternator) and generate mechanical power, which can be used to propel a vehicle embodying the engine system 100.

The electric machine 140 receives the coolant from the cooling system 110. For example, the electric machine 140 can receive the coolant from the coolant storage tank 112 (e.g., via one or more pumps). The coolant can be used to facilitate cooling one or more components of the electric machine 140, such as a stator, a rotor, or other component of the electric machine 140. The coolant is returned to the cooling system 110 via the coolant manifold 200.

The EGR system 150 is configured to route exhaust gases from an outlet of the engine 102 to an inlet of the engine 102. For example, the EGR system can include a conduit and one or more valves that fluidly couple an outlet of the engine 102 to an inlet of the engine 102. The EGR system can also include an EGR cooler that is configured to cool the exhaust gases flowing therethrough.

The EGR system 150 receives the coolant from the cooling system 110. For example, the EGR system 150 can receive the coolant from the coolant storage tank 112 (e.g., via one or more pumps). The coolant can be used to facilitate cooling one or more components of the EGR system 150, such as the EGR cooler, and/or the exhaust gas flowing therethrough. The coolant is returned to the cooling system 110 via the coolant manifold 200.

FIGS. 3 and 4 show perspective views of the coolant manifold 200 of the cooling system 110 for the engine 102. In an example embodiment, the coolant manifold 200 includes a main body 210. The main body 210 includes an outlet port 220. The outlet port defines an outlet axis 222 that extends in an outlet direction 223. The main body 210 includes a plurality of inlet ports 228 in fluid providing communication with the outlet port 220. The plurality of inlet ports 228 includes at least a first inlet port (e.g., a turbo return port 240) and a second inlet port (e.g., a EGR return port 230). The first inlet port defines a first inlet axis (e.g., a turbo axis 242) spaced away from the outlet axis 222. The first inlet axis extends from the main body 210 in a first inlet direction (e.g., a turbo direction 243) at a first non-zero angle (e.g., a non-zero angle 244) with respect to the outlet direction 223. The second inlet port defines a second inlet axis (e.g., a EGR axis 232) spaced away from the outlet axis 222. The second inlet axis extends from the main body 210 in a second inlet direction (e.g., an EGR direction 233) at a second non-zero angle (e.g., a non-zero angle 234) with respect to the outlet direction 223. In the embodiment shown in FIGS. 3-4, the first non-zero angle 244 and the second non-zero angle 234 are different. It should be understood that, although the turbo return port 240 and the EGR return port 230 are described as being the first inlet port and the second inlet port in the example described above, any of the inlet ports 228 described herein can constitute the first inlet port or the second inlet port.

The coolant manifold 200 is configured to receive the coolant from one or more components or sub-systems of the engine system 100, such as the bypass system 114, the surge tank 116, the heat exchanger 118, the turbo device 120, the HVAC system 130, the electric machine 140, and/or the EGR system 150. The coolant manifold 200 is configured to provide the coolant to a downstream component, such as the coolant storage tank 112.

In the embodiment shown in FIGS. 3 and 4, the main body 210, the outlet port 220, and the inlet ports 228 are integrally formed as a single piece. That is, the main body 210, the outlet port 220, and the inlet ports 228 cannot be separated without damaging the main body 210, the outlet port 220, and/or the inlet ports 228.

In some embodiments, the main body 210 defines a central chamber or volume therein that fluidly couples each of the inlet ports 228 to the outlet port 220. In this way, a fluid such as the coolant can flow into the coolant manifold 200 via one or more of the inlet ports 228, through the main body 210, and out of the coolant manifold 200 via the outlet port 220.

The outlet port 220 is configured to provide a fluid such as the coolant to a downstream coolant component, such as the coolant storage tank 112. The outlet port defines the outlet axis 222. The outlet axis 222 extends from the main body 210 in a substantially horizontal direction (e.g., substantially perpendicular to the direction of gravity). The outlet axis 222 is substantially perpendicular to a vertical direction. That is, the outlet direction 223 is a substantially horizontal direction.

The inlet ports 228 includes one or more of an EGR return port 230, a turbo return port 240, a surge tank return port 250, a bypass return port 260, an HVAC return port 270, an electric machine return port 280, and a heat exchanger return port 290. As mentioned above, any of the inlet ports 228 (e.g., any of the EGR return port 230, the turbo return port 240, the surge tank return port 250, the bypass return port 260, the HVAC return port 270, the electric machine return port 280, and/or the heat exchanger return port 290) can be a first inlet port, a second inlet port, a third inlet port, etc.

The EGR return port 230 can be the first inlet port, the second inlet port, the third inlet port, etc. In an example embodiment, the EGR return port 230 is the second inlet port. The EGR return port 230 is in fluid receiving communication with the EGR system 150. The EGR return port 230 is in fluid providing communication with the outlet port 220. In an example embodiment, the EGR return port 230 is configured to route the coolant from the EGR system 150 to the outlet port 220.

The EGR return port 230 has an EGR port diameter at an upstream end of the EGR return port 230 (e.g., at a face of the EGR return port 230). The EGR port diameter may be any one of a first inlet port diameter, a second inlet port diameter, etc. In an example embodiment, the EGR port diameter is the second inlet port diameter, which is different than the first inlet port diameter. The upstream end of the EGR return port 230 may be any one of a first upstream end, a second upstream end, etc. In an example embodiment, the upstream end is the second upstream end. The EGR port diameter is sized to accommodate a conduit (e.g., a first conduit, a second conduit, etc.) upstream of the coolant manifold 200. For example, the EGR port diameter can be sized to accommodate a conduit that fluidly couples the EGR system 150 to the EGR return port 230.

The EGR return port 230 defines an EGR axis 232. The EGR axis 232 can be any of a first inlet axis, a second inlet axis, a third inlet axis, etc. In an example embodiment, the EGR axis 232 is the second inlet axis.

The EGR axis 232 extends from the main body 210 in a substantially horizontal direction, shown as an EGR direction 233. The EGR direction 233 may be one of a first inlet direction, a second inlet direction, a third inlet direction, etc. In an example embodiment, the EGR direction 233 is the second inlet direction.

The EGR axis 232 is spaced away from the outlet axis 222 in a vertical direction (e.g., substantially parallel to the direction of gravity). The EGR axis 232 is at a non-zero angle 234 with respect to the outlet direction 223. The non-zero angle 234 can be any of a first non-zero angle, a second non-zero angle, a third non-zero angle, etc. In an example embodiment, the EGR axis 232 is at the second non-zero angle with respect to the outlet direction 223. The non-zero angle 234 is between 0 degrees and 90 degrees (with 90 degrees being inclusive). For example, when viewed from the horizontal direction, the second non-zero angle (e.g., the non-zero angle 234) is between 90 degrees and 180 degrees, inclusive.

The turbo return port 240 can be the first inlet port, the second inlet port, the third inlet port, etc. In an example embodiment, the turbo return port 240 is the first inlet port. The turbo return port 240 is in fluid receiving communication with the turbo device 120. The turbo return port 240 is in fluid providing communication with the outlet port 220. In an example embodiment, the turbo return port 240 is configured to route the coolant from the turbo device 120 to the outlet port 220.

The turbo return port 240 has a turbo port diameter at an upstream end of the turbo return port 240 (e.g., at a face of the turbo return port 240). The turbo port diameter is different than the EGR port diameter. The turbo port diameter may be any one of the first inlet port diameter, the second inlet port diameter, etc. In an example embodiment, the turbo port diameter is the first inlet port diameter, which is different than the second inlet port diameter. The upstream end of the turbo return port 240 may be any one of a first upstream end, a second upstream end, etc. In an example embodiment, the upstream end is the first upstream end. The turbo port diameter is sized to accommodate a conduit (e.g., a first conduit, a second conduit, etc.) upstream of the coolant manifold 200. For example, the turbo port diameter can be sized to accommodate a conduit that fluidly couples the turbo device 120 to the turbo return port 240.

The turbo return port 240 defines a turbo axis 242. The turbo axis 242 can be any of a first inlet axis, a second inlet axis, a third inlet axis, etc. In an example embodiment, the turbo axis 242 is the first inlet axis.

The turbo axis 242 extends from the main body 210 in a substantially vertical direction, shown as a turbo direction 243. The turbo direction 243 may be one of the first inlet direction, the second inlet direction, the third inlet direction, etc. In an example embodiment, the turbo direction 243 is the first inlet direction. The outlet direction 223 is substantially perpendicular to the first inlet direction (e.g., the turbo direction 243).

The turbo axis 242 is spaced away from the outlet axis 222 in the horizontal direction. The turbo axis 242 is at a non-zero angle 244 with respect to the outlet direction 223. The non-zero angle 244 can be any of the first non-zero angle, the second non-zero angle, the third non-zero angle, etc. In an example embodiment, the turbo axis 242 is at the first non-zero angle with respect to the outlet direction 223. The first non-zero angle 244 is between 0 degrees and 90 degrees (with 90 degrees being inclusive). For example, when viewed from the horizontal direction, the non-zero angle 244 is between 0 degrees and 90 degrees (with 90 degrees being inclusive).

The surge tank return port 250 can be the first inlet port, the second inlet port, the third inlet port, etc. In an example embodiment, the surge tank return port 250 is the first inlet port. The surge tank return port 250 is in fluid receiving communication with the surge tank 116. The surge tank return port 250 is in fluid providing communication with the outlet port 220. In an example embodiment, the surge tank return port 250 is configured to route the coolant from the surge tank 116 to the outlet port 220.

The surge tank return port 250 has a surge tank port diameter at an upstream end of the surge tank return port 250 (e.g., at a face of the surge tank return port 250). The surge tank port diameter is different than the EGR port diameter and the turbo port diameter. The surge tank port diameter may be any one of the first inlet port diameter, the second inlet port diameter, etc. In an example embodiment, the surge tank port diameter is the first inlet port diameter, which is different than the second inlet port diameter. The upstream end of the surge tank return port 250 may be any one of a first upstream end, a second upstream end, etc. In an example embodiment, the upstream end is the first upstream end. The surge tank port diameter is sized to accommodate a conduit (e.g., a first conduit, a second conduit, etc.) upstream of the coolant manifold 200. For example, the surge tank port diameter can be sized to accommodate a conduit that fluidly couples the surge tank 116 to the surge tank return port 250.

The surge tank return port 250 defines a surge tank axis 252. The surge tank axis 252 can be any of a first inlet axis, a second inlet axis, a third inlet axis, etc. In an example embodiment, the surge tank axis 252 is the first inlet axis.

The surge tank axis 252 extends from the main body 210 in a substantially vertical direction, shown as a surge tank direction 253. The surge tank direction 253 may be one of the first inlet direction, the second inlet direction, the third inlet direction, etc. In an example embodiment, the surge tank direction 253 is the first inlet direction. The outlet direction 223 is substantially perpendicular to the first inlet direction (e.g., the surge tank direction 253).

The surge tank axis 252 is spaced away from the outlet axis 222 in the horizontal direction. The surge tank axis 252 is at a non-zero angle 254 with respect to the outlet direction 223. The non-zero angle 254 can be any of the first non-zero angle, the second non-zero angle, the third non-zero angle, etc. In an example embodiment, the surge tank axis 252 is at the first non-zero angle with respect to the outlet direction 223. The non-zero angle 254 is between 0 degrees and 90 degrees (with 90 degrees being inclusive). For example, when viewed from the horizontal direction, the non-zero angle 254 is between 0 degrees and 90 degrees (with 90 degrees being inclusive).

The bypass return port 260 can be the first inlet port, the second inlet port, the third inlet port, etc. In an example embodiment, the bypass return port 260 is the first inlet port. The bypass return port 260 is in fluid receiving communication with the bypass system 114. The bypass return port 260 is in fluid providing communication with the outlet port 220. In an example embodiment, the bypass return port 260 is configured to route the coolant from the bypass system 114 to the outlet port 220.

The bypass return port 260 has a bypass port diameter at an upstream end of the bypass return port 260 (e.g., at a face of the bypass return port 260). The bypass port diameter is different than the EGR port diameter, the turbo port diameter, and the surge tank port diameter. The bypass port diameter may be any one of the first inlet port diameter, the second inlet port diameter, etc. In an example embodiment, the bypass port diameter is the first inlet port diameter, which is different than the second inlet port diameter. The upstream end of the bypass return port 260 may be any one of a first upstream end, a second upstream end, etc. In an example embodiment, the upstream end is the first upstream end. The bypass port diameter is sized to accommodate a conduit (e.g., a first conduit, a second conduit, etc.) upstream of the coolant manifold 200. For example, the bypass port diameter can be sized to accommodate a conduit that fluidly couples the bypass system 114 to the bypass return port 260.

The bypass return port 260 defines a bypass axis 262. The bypass axis 262 can be any of a first inlet axis, a second inlet axis, a third inlet axis, etc. In an example embodiment, the bypass axis 262 is the first inlet axis.

The bypass axis 262 extends from the main body 210 in a substantially vertical direction, shown as a bypass direction 263. The bypass direction 263 may be one of the first inlet direction, the second inlet direction, the third inlet direction, etc. In an example embodiment, the bypass direction 263 is the first inlet direction. The outlet direction 223 is substantially perpendicular to the first inlet direction (e.g., the bypass direction 263).

The bypass axis 262 is spaced away from the outlet axis 222 in the horizontal direction. The bypass axis 262 is at a non-zero angle 264 with respect to the outlet direction 223. The non-zero angle 264 can be any of the first non-zero angle, the second non-zero angle, the third non-zero angle, etc. In an example embodiment, the bypass axis 262 is at the first non-zero angle with respect to the outlet direction 223. The non-zero angle 264 is between 0 degrees and 90 degrees (with 90 degrees being inclusive). For example, when viewed from the horizontal direction, the non-zero angle 264 is between 0 degrees and 90 degrees (with 90 degrees being inclusive).

The HVAC return port 270 can be the first inlet port, the second inlet port, the third inlet port, etc. In an example embodiment, the HVAC return port 270 is the first inlet port. The HVAC return port 270 is in fluid receiving communication with the HVAC system 130. The HVAC return port 270 is in fluid providing communication with the outlet port 220. In an example embodiment, the HVAC return port 270 is configured to route the coolant from the HVAC system 130 to the outlet port 220.

The HVAC return port 270 has a HVAC port diameter at an upstream end of the HVAC return port 270 (e.g., at a face of the HVAC return port 270). The HVAC port diameter is different than the EGR port diameter, the turbo port diameter, the surge tank port diameter, and the bypass port diameter. The HVAC port diameter may be any one of the first inlet port diameter, the second inlet port diameter, etc. In an example embodiment, the HVAC port diameter is the first inlet port diameter, which is different than the second inlet port diameter. The upstream end of the HVAC return port 270 may be any one of a first upstream end, a second upstream end, etc. In an example embodiment, the upstream end is the first upstream end. The HVAC port diameter is sized to accommodate a conduit (e.g., a first conduit, a second conduit, etc.) upstream of the coolant manifold 200. For example, the HVAC port diameter can be sized to accommodate a conduit that fluidly couples the HVAC system 130 to the HVAC return port 270.

The HVAC return port 270 defines a HVAC axis 272. The HVAC Axis 272 can be any of a first inlet axis, a second inlet axis, a third inlet axis, etc. In an example embodiment, the HVAC axis 272 is the first inlet axis.

The HVAC axis 272 extends from the main body 210 in a substantially vertical direction, shown as an HVAC direction 273. The HVAC direction 273 may be one of the first inlet direction, the second inlet direction, the third inlet direction, etc. In an example embodiment, the HVAC direction 273 is the first inlet direction. The outlet direction 223 is substantially perpendicular to the first inlet direction (e.g., the HVAC direction 273).

The HVAC axis 272 is spaced away from the outlet axis 222 in the horizontal direction. The HVAC axis 272 is at a non-zero angle 274 with respect to the outlet direction 223. The non-zero angle 274 can be any of the first non-zero angle, the second non-zero angle, the third non-zero angle, etc. In an example embodiment, the HVAC axis 272 is at the first non-zero angle with respect to the outlet direction 223. The non-zero angle 274 is between 0 degrees and 90 degrees (with 90 degrees being inclusive). For example, when viewed from the horizontal direction, the non-zero angle 274 is between 0 degrees and 90 degrees (with 90 degrees being inclusive).

The electric machine return port 280 can be the first inlet port, the second inlet port, the third inlet port, etc. In an example embodiment, the electric machine return port 280 is the first inlet port. The electric machine return port 280 is in fluid receiving communication with the electric machine 140. The electric machine return port 280 is in fluid providing communication with the outlet port 220. In an example embodiment, the electric machine return port 280 is configured to route the coolant from electric machine 140 to the outlet port 220.

The electric machine return port 280 has an electric machine port diameter at an upstream end of the electric machine return port 280 (e.g., at a face of the electric machine return port 280). The electric machine port diameter is different than the EGR port diameter, the turbo port diameter, the surge tank port diameter, the bypass port diameter, and the HVAC port diameter. The electric machine port diameter may be any one of the first inlet port diameter, the second inlet port diameter, etc. In an example embodiment, the electric machine port diameter is the first inlet port diameter, which is different than the second inlet port diameter. The upstream end of the electric machine return port 280 may be any one of a first upstream end, a second upstream end, etc. In an example embodiment, the upstream end is the first upstream end. The electric machine port diameter is sized to accommodate a conduit (e.g., a first conduit, a second conduit, etc.) upstream of the coolant manifold 200. For example, the electric machine port diameter can be sized to accommodate a conduit that fluidly couples the electric machine 140 to the electric machine return port 280.

The electric machine return port 280 defines an electric machine axis 282. The electric machine axis 282 can be any of a first inlet axis, a second inlet axis, a third inlet axis, etc. In an example embodiment, the electric machine axis 282 is the first inlet axis.

The electric machine axis 282 extends from the main body 210 in a substantially vertical direction, shown as an electric machine direction 283. The electric machine direction 283 may be one of the first inlet direction, the second inlet direction, the third inlet direction, etc. In an example embodiment, the electric machine direction 283 is the first inlet direction. The outlet direction 223 is substantially perpendicular to the first inlet direction (e.g., the electric machine direction 283). The electric machine axis 282 is substantially parallel to the turbo axis 242, the surge tank axis 252, the bypass axis 262, and/or the HVAC axis 272.

The electric machine direction 283 is substantially opposite the turbo direction 243, the surge tank direction 253, the bypass direction 263, and/or the HVAC direction 273. For example, as shown in FIGS. 3 and 4, an open end of the electric machine return port 280 faces the electric machine direction 283. In the orientation of the coolant manifold 200 shown in FIG. 3, the electric machine direction 283 is a vertically downwards direction (e.g., along the direction of gravity). An open end of the turbo return port 240, the surge tank return port 250, the bypass return port 260, and/or the HVAC return port 270 face a the turbo direction 243, the surge tank direction 253, the bypass direction 263, and/or the HVAC direction 273, respectively, substantially opposite the HVAC direction 273. The turbo direction 243, the surge tank direction 253, the bypass direction 263, and/or the HVAC direction 273 is/are a vertically upwards direction (e.g., opposite the direction of gravity).

The electric machine axis 282 is spaced away from the outlet axis 222 in the horizontal direction. The electric machine axis 282 is at a non-zero angle 284 with respect to the outlet direction 223. The non-zero angle 284 can be any of the first non-zero angle, the second non-zero angle, the third non-zero angle, etc. In an example embodiment, the electric machine axis 282 is at the first non-zero angle with respect to the outlet direction 223. The non-zero angle 284 is between 0 degrees and 90 degrees (with 90 degrees being inclusive). For example, when viewed from the horizontal direction, the non-zero angle 284 is between 0 degrees and 90 degrees (with 90 degrees being inclusive).

The heat exchanger return port 290 can be the first inlet port, the second inlet port, the third inlet port, etc. In an example embodiment, the heat exchanger return port 290 is the third inlet port. The heat exchanger return port 290 is in fluid receiving communication with the heat exchanger 118. The heat exchanger return port 290 is in fluid providing communication with the outlet port 220. In an example embodiment, the heat exchanger return port 290 is configured to route the coolant from the heat exchanger 118 to the outlet port 220.

The heat exchanger return port 290 has a heat exchanger port diameter at an upstream end of the heat exchanger return port 290 (e.g., at a face of the heat exchanger return port 290). The heat exchanger port diameter is different than the EGR port diameter, the turbo port diameter, the surge tank port diameter, the bypass port diameter, the HVAC port diameter, and the electric machine port diameter. The heat exchanger port diameter may be any one of the first inlet port diameter, the second inlet port diameter, etc. In an example embodiment, the electric machine port diameter is a third inlet port diameter, which is different than the first inlet port diameter and the second inlet port diameter. The upstream end of the heat exchanger return port 290 may be any one of a first upstream end, a second upstream end, etc. In an example embodiment, the upstream end is a third upstream end. The heat exchanger port diameter is sized to accommodate a conduit (e.g., a first conduit, a second conduit, etc.) upstream of the coolant manifold 200. For example, the heat exchanger port diameter can be sized to accommodate a conduit that fluidly couples the heat exchanger 118 to the heat exchanger return port 290.

The heat exchanger return port 290 defines a heat exchanger axis 292. The heat exchanger axis 292 can be any of a first inlet axis, a second inlet axis, a third inlet axis, etc. In an example embodiment, the heat exchanger axis 292 is the third inlet axis.

The heat exchanger axis 292 extends from the main body 210 in an angled direction, shown as a heat exchanger direction 293, that is angled with respect to both the horizontal direction and the vertical direction. The heat exchanger direction 293 may be one of the first inlet direction, the second inlet direction, the third inlet direction, etc. In an example embodiment, the heat exchanger direction 293 is the third inlet direction.

The heat exchanger axis 292 is spaced away from the outlet axis 222. The heat exchanger axis 292 is at a non-zero angle 294 with respect to the outlet direction 223. The non-zero angle 294 can be any of the first non-zero angle, the second non-zero angle, the third non-zero angle, etc. In an example embodiment, the heat exchanger axis 292 is at the third non-zero angle with respect to the outlet direction 223. The non-zero angle 294 has a vertical component that is between zero degrees and 90 degrees (with 90 degrees being inclusive), and a horizontal component that is between zero degrees and 90 degrees (with 90 degrees being inclusive).

In an example embodiment, the coolant manifold 200 includes one or more inlet ports 228 and the outlet port 220. The coolant manifold 200 is configured to receive a fluid (e.g., coolant) via the one or more inlet ports 228 and to supply the fluid to a downstream component or system, such as a water pump. The water pump can increase the pressure of the fluid and provide the fluid to one or more downstream devices, such as the turbo device 120, the HVAC system 130, the electric machine 140, the EGR system 150, and/or one or more other components or systems, such as an air compressor, or other suitable component/system.

In another example embodiment, the coolant manifold 200 is configured to receive a fluid (e.g., the coolant) at various operating temperatures, which can vary based on the application or use case of the coolant manifold 200. By way of example, the coolant manifold 200 can receive the fluid at or below a thermostat open temperature. The thermostat open temperature can be approximately 200° F., such as between 180° F. and 200° F., inclusive. By way of another example, the coolant manifold 200 can receive the fluid above the thermostat open temperature.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

References herein to the positions of elements (e.g., “top,” “bottom,” “above,” “below,” “left,” “right”) are merely used to describe the orientation of various elements in the FIGURES. It should be noted that the orientation of various elements may differ according to other exemplary embodiments, and that such variations are intended to be encompassed by the present disclosure.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. A coolant manifold for an engine cooling system comprising:
a main body comprising an outlet port defining an outlet axis that extends in an outlet direction and plurality of inlet ports in fluid providing communication with the outlet port, the plurality of inlet ports comprising:
a first inlet port defining a first inlet axis spaced away from the outlet axis, the first inlet axis extending from the main body in a first inlet direction at a first non-zero angle with respect to the outlet direction; and
a second inlet port defining a second inlet axis spaced away from the outlet axis, the second inlet axis extending from the main body in a second inlet direction at a second non-zero angle with respect to the outlet direction.

2. The coolant manifold of claim 1, wherein the first non-zero angle is different than the second non-zero angle.

3. The coolant manifold of claim 1, wherein the outlet direction is substantially perpendicular to the first inlet direction.

4. The coolant manifold of claim 1, wherein:
the second inlet axis is spaced away from the outlet axis in a vertical direction;
the outlet axis is substantially perpendicular to the vertical direction;
the second inlet axis is substantially perpendicular to the vertical direction; and
the second non-zero angle is between 90 degrees and 180 degrees, inclusive.

5. The coolant manifold of claim 1, wherein:
the first inlet port has a first inlet port diameter at a first upstream end of the first inlet port, the first inlet port sized to accommodate a first conduit upstream of the coolant manifold; and
the second inlet port has a second inlet port diameter at a second upstream end of the second inlet port, the second inlet port diameter different than the first inlet port diameter, and the second inlet port sized to accommodate a second conduit upstream of the coolant manifold.

6. The coolant manifold of claim 1, wherein the plurality of inlet ports further comprises:
a third inlet port defining a third inlet axis spaced away from the outlet axis, the third inlet axis extending from the main body in a third inlet direction at a third non-zero angle with respect to the outlet direction.

7. The coolant manifold of claim 6, wherein the third non-zero angle has a vertical component that is between zero degrees and 90 degrees, inclusive, and a horizontal component that is between zero degrees and 90 degrees, inclusive.

8. The coolant manifold of claim 7, wherein the plurality of inlet ports further comprises:
a fourth inlet port defining a fourth inlet axis spaced away from the outlet axis, the fourth inlet axis extending from the main body in a fourth inlet direction at a fourth non-zero angle with respect to the outlet direction.

9. The coolant manifold of claim 8, wherein the plurality of inlet ports further comprises:
a fifth inlet port defining a fifth inlet axis spaced away from the outlet axis, the fifth inlet axis extending from the main body in a fifth inlet direction at a fifth non-zero angle with respect to the outlet direction.

10. The coolant manifold of claim 9, wherein the plurality of inlet ports further comprises:
a sixth inlet port defining a sixth inlet axis spaced away from the outlet axis, the sixth inlet axis extending from the main body in a sixth inlet direction at a sixth non-zero angle with respect to the outlet direction.

11. The coolant manifold of claim 10, wherein the plurality of inlet ports further comprises:
a seventh inlet port defining a seventh inlet axis spaced away from the outlet axis, the seventh inlet axis extending from the main body in a seventh inlet direction at a seventh non-zero angle with respect to the outlet direction.

12. The coolant manifold of claim 1, wherein the main body, the outlet port, and the plurality of inlet ports are integrally formed as one piece.

13. An engine system, comprising:
an engine;
at least one cooling system component;
at least one non-cooling system component;
a downstream coolant component; and
a coolant manifold comprising:
a main body defining a central chamber;
an outlet port extending in an outlet direction and fluidly connected to the central chamber and the downstream coolant component, the outlet port defining an outlet axis;
a plurality of inlet ports, each of the plurality of inlet ports extending in an inlet direction, each of the plurality of inlet ports fluidly connected to the central chamber and (i) one of the at least one cooling system component or (ii) one of the at least one non-cooling system component, each of the plurality of inlet ports defining an inlet axis spaced away from the outlet axis, each inlet axis extending from the main body in an inlet direction at a non-zero angle with respect to the outlet direction.

14. The engine system of claim 13, wherein the main body, the outlet port, and the plurality of inlet ports are integrally formed as one piece.

15. The engine system of claim 13, wherein the at least one non-cooling system component comprises at least one of a turbo device, an HVAC system, an electric machine, and an EGR system.

16. The engine system of claim 13, wherein the downstream coolant component comprises a coolant storage tank.

17. The engine system of claim 13, wherein the at least one cooling system component comprises at least one of a bypass system, a surge tank, and a heat exchanger.

18. The engine system of claim 13, wherein each of the plurality of inlet ports defines an inlet port diameter at an upstream end of the respective inlet port, the inlet port diameter of each inlet port of the plurality of inlet ports being different than the inlet port diameter of at least one other inlet port of the plurality of inlet ports.

19. The engine system of claim 13, wherein the outlet direction of the outlet port is substantially perpendicular to the inlet direction of at least one of the plurality of inlet ports.

20. The engine system of claim 13, wherein the outlet direction of the outlet port is at an angle between 90 and 180 degrees inclusive relative to the inlet direction of at least one of the plurality of inlet ports.
